(19) United States
(12) Patent Application Publication
(10) Pub. No.: US 2011/0292211 A1
(43) Pub. Date: Dec. 1, 2011

(54) VEHICLE DESIGN

(76) Inventor: Shmuel ABRAHAM, (US)

(21) Appl. No.: 13/114,174

(22) Filed: May 24, 2011

Related U.S. Application Data
(60) Provisional application No. 61/347,698, filed on May 24, 2010.

(51) Int. Cl. F41A 23/34; H04N 7/18; B60K 15/077; B60K 17/34; B60R 5/00; F41H 7/02

(52) U.S. Cl. 348/148; 296/24.43; 89/36.08; 137/561 A; 180/233; 89/37.03

(57) ABSTRACT

A 4-wheel drive improved motor vehicle design may have a passenger cabin both at the front and at the rear of said vehicle. The central portion of the vehicle may be partly occupied by the vehicle engine and partly by a framework for supporting essential supplies and personal baggage. The spaced-apart passenger cabins may increase the probability of survival should the vehicle be attacked or undermined A large fuel tank may be combined with comfortable seating to enable the passengers and the vehicle to carry out extended missions.

### CROSS REFERENCE TO RELATED APPLICATIONS

This Application claims the benefit of U.S. Provisional Application Ser. No. 61/347,698, filed May 24, 2010, which is hereby incorporated by reference in its entirety.

### FIELD OF INVENTION

The present invention relates to all-terrain vehicles. More particularly, the invention provides a 4-wheel drive vehicle having a passenger cabin both at the front and at the rear, the central portion of the vehicle being occupied by the engine and by racks for baggage, water, and any other items needed for extended travel.

### BACKGROUND OF THE INVENTION

Those needing to travel in unstable and dangerous areas, for example newspaper reporters, foreign aid personnel, United Nations (UN) monitors and the like need a degree of protection beyond that provided by a jeep. However the cost and size of an APC (Armed Personnel Carrier) is far beyond what is needed for such purposes. There is thus a gap between the Jeep and the APC, which is intended to be filled by the vehicle described in the present invention.

Prior art vehicles, as seen in several recent US patents, provide a fair assessment of the state of the art.

In U.S. Pat. No. 4,303,271 Law discloses a military vehicle which can be arranged either to carry troops or cargo. The vehicle has a high profile and troops are exposed to small arms fire. The vehicle would be restricted to safe areas and would have difficulty in traversing very rough ground.

Eckstedt discloses an armored low-profile 8-wheeled design in U.S. Design Pat. No. D499,670 S and again in U.S. D527,684S. Such vehicle is suitable for traversing very rough ground.

Hepner et al. disclose a 4-wheel vehicle in US patent application 2006/0273566 and again in U.S. Pat. No. 7,464,963 B2. The vehicle is intended for carrying personnel, and is equipped with removable roll bars which are needed because of the vehicle high profile. Only the driver's cab is armored.

The central feature of the vehicle disclosed by Eckstedt in U.S. Pat. No. 7,108,093 is the unique engine position, which is mounted at the outer rear corner of the vehicle on a vertical axis. The primary advantage of this arrangement is that this provides easy access for engine maintenance work.

An undesirable feature of all prior art vehicles is that grenade, missile or rifle fire hitting the vehicle may cause the loss of all personnel and consequently also of the vehicle.

### SUMMARY

A 4-wheel drive improved motor vehicle design may have a passenger cabin both at the front and at the rear of said vehicle. The central portion of the vehicle may be partly occupied by the vehicle engine and partly by a framework for supporting essential supplies and personal baggage. The spaced-apart passenger cabins may increase the probability of survival should the vehicle be attacked or undermined A large fuel tank may be combined with comfortable seating to enable the passengers and the vehicle to carry out extended missions.

It is therefore the object of the present invention to obviate the disadvantages of prior art vehicles and to provide a low-profile vehicle which can be used over rough terrain and which greatly increases the probability of survival if/when the vehicle is attacked.

The present invention achieves the above object by providing a 4-wheel drive low-profile motor vehicle having a passenger cabin both at the front and at the rear of said vehicle, the central portion of said vehicle being partly occupied by the vehicle engine and by a framework for supporting essential supplies and personal baggage.

In a preferred embodiment of the present invention there is provided a vehicle wherein the wall of each passenger cabin facing said central portion is armored.

In a further preferred embodiment the whole vehicle may be armored.

In a most preferred embodiment of the present invention there is provided a vehicle supporting a large fuel tank provided with internal baffles to prevent fuel sloping, said fuel tank, in combination with padded passenger seating making possible long distance missions without refueling.

In another preferred embodiment of the present invention there is provided a vehicle wherein the rear wheel suspension is arranged to allow the rear passenger cabin to be used for transporting a heavy load.

In a further preferred embodiment of the present invention there is provided a vehicle wherein the road wheels are positioned to extend beyond the body of said vehicle on all four sides thereof.

In yet a further preferred embodiment of the present invention said vehicle is further provided with a camera mounted at the rear of said vehicle, said camera being operatively linked to a display screen disposed within view of the vehicle driver.

In another preferred embodiment of the present invention said vehicle is further provided with camouflage netting covering said central portion.

It will now be realized that the unique structure of the vehicle provides a safer means of transport than currently known vehicles. Should the vehicle come under attack, the separated passenger cabins increase the probability of survival of at least some of the persons in the vehicle. The vehicle is unlikely to be forced to a standstill either by rough terrain or by running out of fuel. In extremely dangerous areas a machine gun maybe mounted on the vehicle roof yet can be operated from inside the vehicle. Obviously the degree of protection offered is less than that of an APC, but goes far beyond that offered by a jeep. The gearing provided at the inner side of all wheels allows the half shafts to be positioned further above ground and thus travel over a rocky surface is possible.

The invention will now be described further with reference to the accompanying drawings, which represent by example preferred embodiments of the invention. Structural details are shown only as far as necessary for a fundamental understanding thereof. The described examples, together with the drawings, will make apparent to those skilled in the art how further forms of the invention may be realized.

### BRIEF DESCRIPTION OF THE DRAWINGS

FIG. 1 is an elevational see-through view of a preferred embodiment of the vehicle according to an embodiment of the invention;

FIG. 2 is a see-through plan view of an embodiment of the vehicle

FIG. 3 is an elevational see-through view of a preferred embodiment of the vehicle armed with a machine gun, according to an embodiment of the invention; and

FIG. 4 is a front elevational see-through view of an embodiment seen in FIG. 3 of the vehicle without the machine gun, showing the ground clearance.

### DETAILED DESCRIPTION

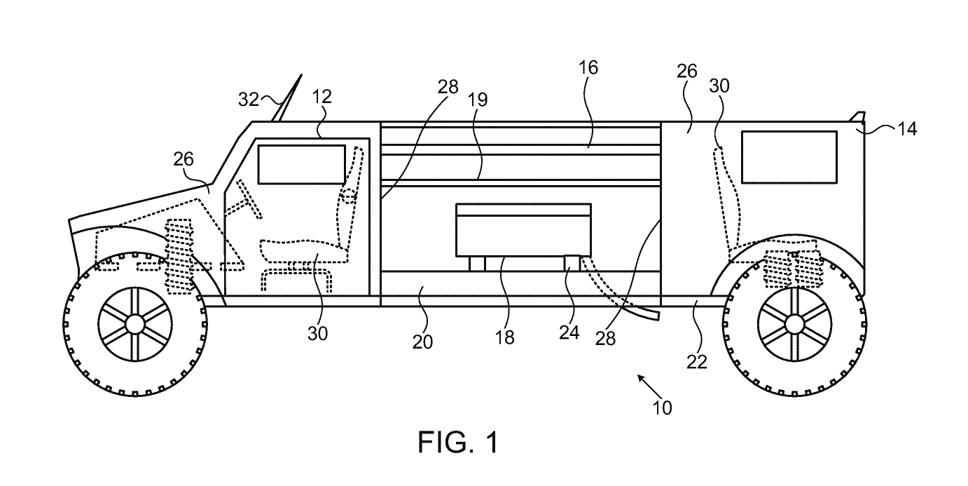

There is seen in FIG. 1 a 4-wheel drive low-profile motor vehicle 10 having a passenger cabin both at the front 12 and at the rear 14 of the vehicle. The central portion 16 of the vehicle 10 is partly occupied by the vehicle engine 18 and by a framework 19 for supporting essential supplies and personal baggage.

The engine 18 together with its attached gearbox 20 is attached to the vehicle chassis 22 on a triangular framework 24 so that twisting forces of the chassis 22 when traversing rough ground are not transmitted to the engine 18.

Suitable padding 30 is provided on the passenger and driver's seat to facilitate the execution of long journeys and a GPS system 32 is installed for navigation.

Preferably armor 26 extends around each passenger cabin, including the cabin wall 28 facing the central portion 16 of the vehicle 10.

With reference to the rest of the figures, similar reference numerals have been used to identify similar parts.

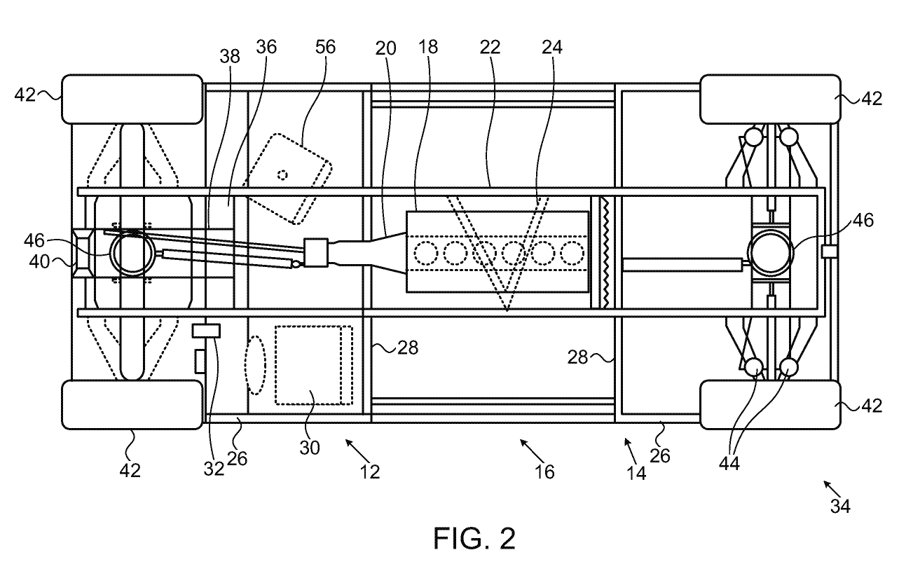

Turning now to FIG. 2 there is illustrated a vehicle 34 provided with a large fuel tank 36, this tank being provided with internal baffles 38 to prevent fuel sloping which could destabilize the vehicle. The large fuel tank 36 in combination with padded 30 seating makes feasible long distance travel without refueling. The large fuel tank 36 utilizes the space made available at the front of the vehicle by the absence of the engine 18 which is located in the mid section 16.

A cable drum 40 for rescuing the vehicle 34 itself or for other rescue work may be attached at the front center of the vehicle chassis 22, the drum 40 being driven directly from the gearbox 20.

The road wheels 42 may be positioned to extend beyond the body of the vehicle 34 on all four sides thereof.

The rear wheel suspension 44 may be arranged to allow the rear passenger cabin 14 to be used for transporting a heavy load.

The two differential gear housings 46 may be manufactured for example in conformity with patent no. WO2005/003599.

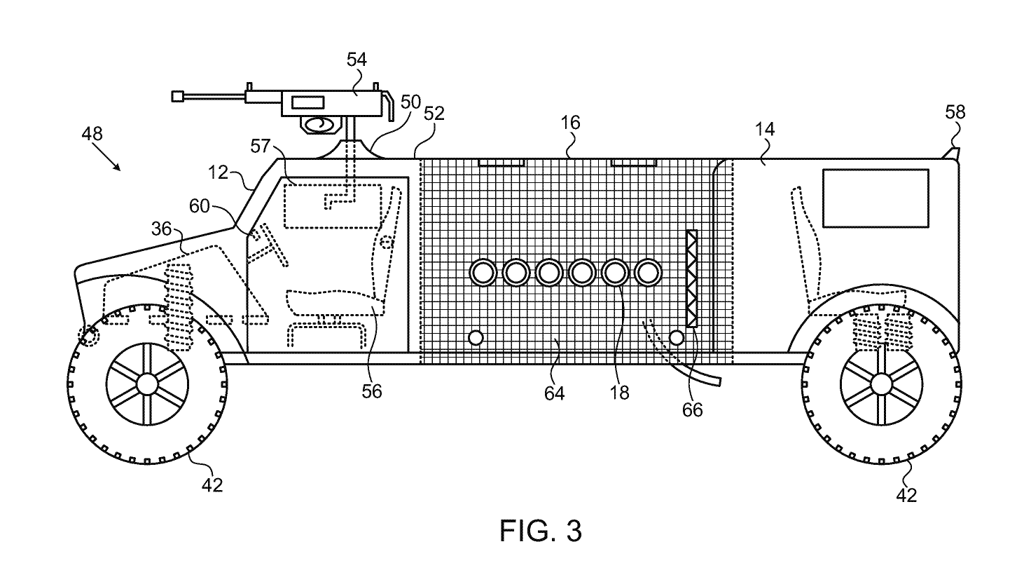

Referring now to FIG. 3, there is depicted a vehicle 48 further provided with a socket 50 disposed on a vertical axis on the roof 52 of the forward passenger cabin 12. The socket 50 may be arranged to support a revolvable machine gun 54. The machine gun 54 may be directly linked to a revolvable seat 56 inside the front passenger cabin 12 by means of a linkage provided between the angle of the swinging seat 56 and the angle of operation of the machine gun. In another embodiment (not shown) this angle, as well as angle of elevation and control of the trigger, are electrically operated from within the vehicle and thus eliminate he need for the gun operator to take up an exposed position on the roof 52 of the forward passenger cabin 12.

The vehicle 48 is further provided with a camera 58 mounted at the rear of the vehicle, the camera 58 being operatively linked to a display screen 60 disposed within view of the vehicle driver.

Readily removable camouflage netting 64 covers the vehicle center portion 16. The engine radiator 66 is arranged to draw in cooling air which easily flows through the netting 64.

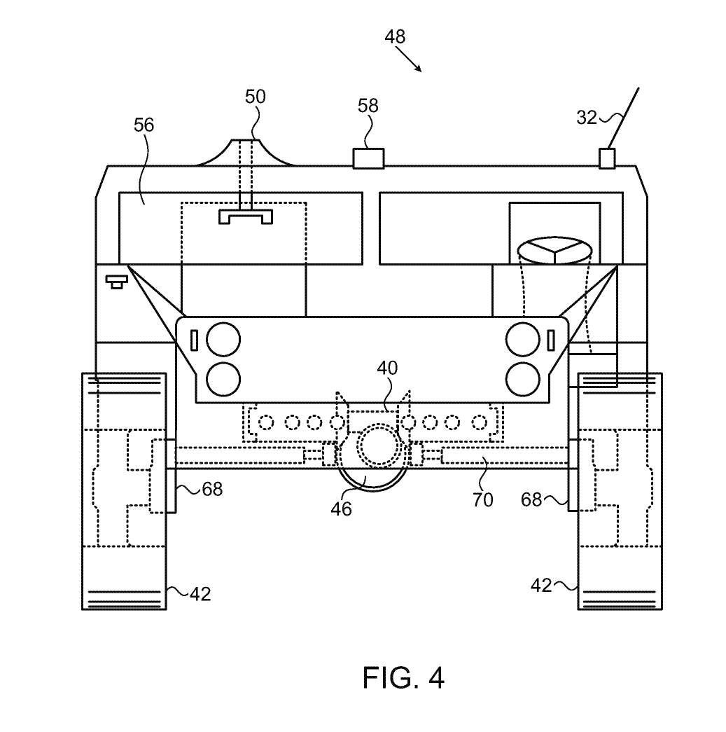

The gearing 68 provided at the inner side of all road wheels 42 is seen in FIG. 4. The gearing 68 allows the half shafts 70 to be positioned further above ground level than would be possible if the half-shafts 70 were on the same axis as the wheels 42. Adequate ground clearance of the vehicle 48 is clearly seen in the figure.

The scope of the described invention is intended to include all embodiments coming within the meaning of the following claims. The foregoing examples illustrate useful forms of the invention, but are not to be considered as limiting its scope, as those skilled in the art will readily be aware that additional variants and modifications of the invention can be formulated without departing from the meaning of the following claims.

We claim:

1. A 4-wheel drive low-profile motor vehicle comprising a first passenger cabin at the front of said vehicle and a second passenger cabin at the rear of said vehicle, the central portion of said vehicle being partly occupied by the vehicle engine and by a framework for supporting essential supplies and personal baggage.

2. The vehicle as claimed in claim 1, wherein the wall of each passenger cabin facing said central portion is armored.

3. The vehicle as claimed in claim 1, supporting a large fuel tank provided with internal baffles to prevent fuel sloping, said fuel tank, in combination with padded passenger seating making possible long distance missions.

4. The vehicle as claimed in claim 1, wherein the rear wheel suspension is arranged to allow the rear passenger cabin to be used for transporting a heavy load.

5. The vehicle as claimed in claim 1, wherein the road wheels are positioned to extend beyond the body of said vehicle on all four sides thereof.

6. The vehicle as claimed in claim 1 further provided with a socket disposed on a vertical axis on the roof of the forward passenger cabin, said socket being arranged to support a revolvable machine gun, said machine gun being linked to a revolvable seat inside one of said passenger cabins by means of a linkage provided between the angle of said swinging seat and the angle of operation of said machine gun.

7. The vehicle as claimed in claim 1 further provided with a camera mounted at the rear of said vehicle, said camera being operatively linked to a display screen disposed within view of the vehicle driver.

8. The vehicle as claimed in claim 1 further provided with netting covering said central portion
